(19) United States
(12) Patent Application Publication
(10) Pub. No.: US 2016/0228219 A1
(43) Pub. Date: Aug. 11, 2016

(54) Osteotome for transcrestal sinus floor elevation

(71) Applicant: Deguo Chu, Beijing (CN)

(72) Inventor: Deguo Chu, Beijing (CN)

(21) Appl. No.: 14/986,720

(22) Filed: Jan. 3, 2016

(30) Foreign Application Priority Data
Feb. 10, 2015 (CN) 201510069990.9

(51) Int. Cl. A61C 8/00

(52) U.S. Cl. CPC A61C 8/0092

(57) ABSTRACT

An osteotome for transcrestal sinus floor elevation includes a working portion and a handle. A notch is provided on the working portion for peeling off maxillary sinus floor mucosa all around to enlarge a lifting scope of maxillary sinus floor. An end surface of the working portion is a plane. The end thickness of the working portion is from 0.3mm to 1.5mm. By the notch, the working portion is changed to be semi-cylindrical or incomplete cylindrical; while lifting the maxillary sinus through the improved osteotome, under the premise of preparing the implanting tooth crypt holes with the same diameter, the osteotome is capable of peeling off the sinus floor mucosa all around after going deep into the maxillary sinus, to enlarge the lifting scope of the maxillary sinus floor, thus the elevation amplitude of the maxillary sinus floor is improved.

### CROSS REFERENCE OF RELATED APPLICATION

The present invention claims priority under 35 U.S.C. 119(a-d) to CN 201510069990.9, filed Feb. 10, 2015.

### BACKGROUND OF THE PRESENT INVENTION

1. Field of Invention

The present invention relates to the field of medical apparatus, and more particularly to an osteotome for transcrestal sinus floor elevation.

2. Description of Related Arts

After the lack of maxillary posterior teeth, due to lower maxillary sinus floor, the vertical bone mass is inadequate, which is a problem often encountered in implant surgery.

Maxillary sinus floor elevation means that elevation after peeling off maxillary sinus mucosa from sinus floor, implants bone graft materials between sinus floor mucosa and sinus floor bone to increase the height of bones, thus the need for bone mass is met while dental implantation.

Currently, the maxillary sinus floor elevation technique commonly used in clinical practice includes transcrestal maxillary sinus floor elevation technique and lateral window maxillary sinus floor elevation technique. The lateral window maxillary sinus floor elevation technique opens a window through the lateral wall of the maxillary sinus, which generally starts forwardly from the zygomatic alveolar ridge trailing edge to a position of the anterior inclined plane with a length of 15 mm for opening the window. Through the window, the maxillary sinus floor mucosa is peeled off and inwardly upwardly pushed, and then the bone substitute is implanted. For the lateral window maxillary sinus floor elevation technique, the elevation amplitude is enhanced, but the surgical trauma is great, there may be sinus floor mucosal rupture, infection and other complications. The transcrestal maxillary sinus floor elevation technique prepares implanting holes from the alveolar ridge crest; while approaching the sinus floor, the sinus floor bone is impacted into the sinus by the special osteotome for elevating the sinus floor mucosa. According to the elevation height what is needed, the bone substitute is selectively implanted or the implant is directly implanted. The transcrestal maxillary sinus floor elevation technique has little trauma, slight postoperative reaction, and is easily accepted by patients. However, the currently used transcrestal maxillary sinus floor elevation technique has limited elevation amplitude which is generally not more than 5 mm, while approaching or exceeding 5 mm, the risk of penetrating through the sinus floor mucosa is increased; once the sinus floor mucosa is penetrated through, it is hard to remedy. Therefore, when the expected lifting amplitude what is needed is more than 5 mm, due to the lack of suitably special osteotome, most expects will recommend the lateral window maxillary sinus floor elevation technique with large trauma instead of the transcrestal maxillary sinus floor elevation technique.

As shown in FIG. 5, in the existing transcrestal maxillary sinus floor elevation technique, the shape of the working portion thereof is cylindrical, and a top end thereof is concaved. This osteotome surgery can only elevate the maxillary sinus floor whose diameter is equal to the diameter of the end of the osteotome, thus the elevation amplitude of the maxillary sinus is limited, which is not more than 5 mm, otherwise easily lead to damaged sinus floor mucosa.

### SUMMARY OF THE PRESENT INVENTION

An object of the present invention is to provide an osteotome for transcrestal sinus floor elevation, which is capable of expanding the elevation scope of the maxillary sinus floor to further elevate the amplitude of the maxillary sinus floor based on the same diameter approach, thereby overcoming the shortcomings of the existing technology.

Accordingly, in order to accomplish the above object, the technical solution adopted by the present invention is as follows.

An osteotome for transcrestal sinus floor elevation, comprises a working portion and a handle,

wherein a notch is provided on the working portion for peeling off maxillary sinus floor mucosa all around to enlarge a lift area of maxillary sinus floor, an end surface of the working portion is a plane.

Preferably, an end thickness of the working portion is from 0.3 mm to 1.5 mm. Preferably, a diameter of the working portion is 2.8 mm, 3.5 mm or 4.1 mm. Preferably, both the working portion and the handle are made of 2Cr3 stainless steel.

Preferably, the handle is straight or curved.

Compared with the existing technologies, beneficial effects of the present invention are as below. The notch is provided on the working portion, the end thickness of the working portion is from 0.3 mm to 1.5 mm; by providing the notch on the cylindrical working portion of the osteotome in the existing technologies, the working portion is changed to be semi-cylindrical or incomplete cylindrical; while elevating the maxillary sinus through the improved osteotome, under the premise of preparing the implanting tooth crypt holes with the same diameter, the osteotome is capable of peeling off the sinus floor mucosa all around after going deep into the maxillary sinus, to enlarge the elevation scope of the maxillary sinus floor, thus the elevation amplitude of the maxillary sinus floor is improved.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an osteotome for transcrestal sinus floor elevation according to a preferred embodiment of the present invention.

FIG. 2 is an enlarged schematic view of a working portion in FIG. 1.

FIG. 3 is a perspective view of an osteotome for transcrestal sinus floor elevation A.

FIG. 4 is a perspective view of an osteotome for transcrestal sinus floor elevation B.

FIG. 5 shows using states of the conventional osteotome.

FIG. 6 shows using states of the osteotome for transcrestal sinus floor elevation A of the present invention.

FIG. 7 shows using states of the osteotome for transcrestal sinus floor elevation B of the present invention.

FIG. 8 is a schematic view of the present invention after lifting maxillary sinus floor.

In the drawings, 1: working portion; 2: handle; 3: graduation; 4: notch; 5: sinus floor mucosa; 6: sinus floor sclerotin; α: angle between an end surface of the working portion and the notch.

### DETAILED DESCRIPTION OF THE PREFERRED EMBODIMENT

The present invention is further described in detail accompanying with the embodiments and drawings.

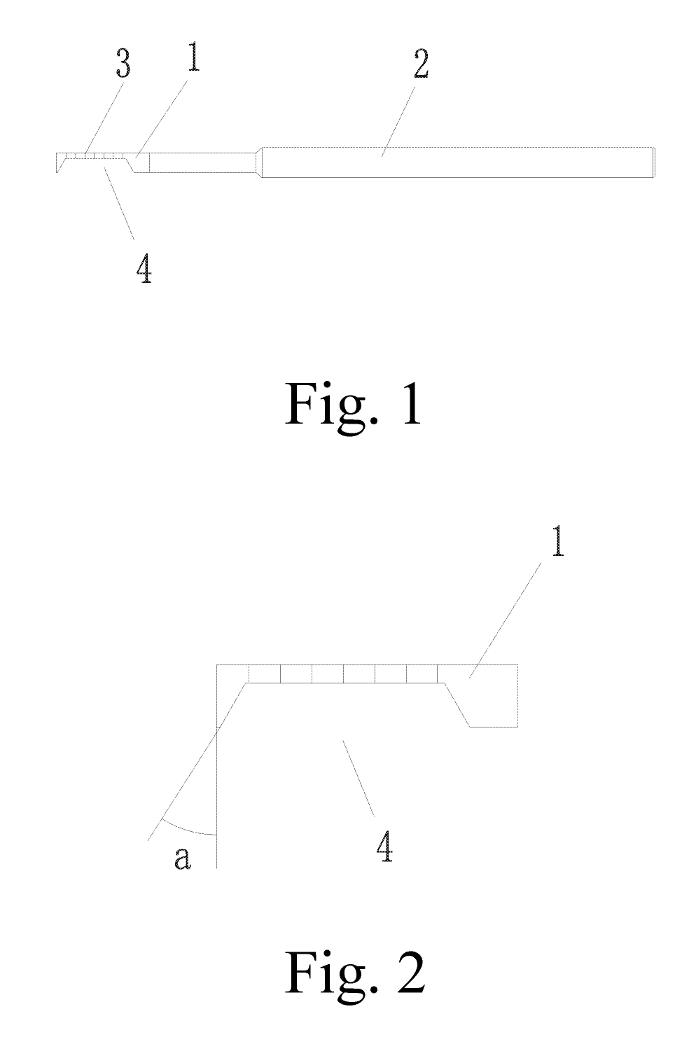

Referring to FIG. 1 of the drawings, an osteotome for transcrestal sinus floor elevation according to a preferred embodiment of the present invention is illustrated, comprising a working portion 1 and a handle 2. Based on a remained thickness of an end of the working portion 1 is 0.3 mm-1.5 mm, a notch 4 is provided on the working portion 1.

In the present invention, preferably, the remained thickness of the end of the working portion 1 is 0.5 mm-1 mm, which is moderate. As shown in FIG. 2, an angle α of 30° is provided between an end face of the working portion 1 and the notch, that is to say, an angle, between an inner wall of the notch 4 close to the end surface of the working portion 1 and a bottom plane of the notch 4 is 120°.

By the above mentioned structure, not because the thickness of the working portion is too thin, the sinus floor mucosa is damaged during surgery; also not because the thickness of the working portion is too thick, the sinus floor mucosa is not easily peeled off. By the notch 4, the working portion 1 is changed to be semi-cylindrical or incomplete cylindrical; under the premise of preparing the implanting tooth crypt holes with the same diameter, the osteotome is capable of peeling off the sinus floor mucosa all around after going deep into the maxillary sinus, to enlarge the lifting scope of the maxillary sinus floor, thus the elevation amplitude of the maxillary sinus floor is improved. The working portion 1 is marked with graduations 3, a distance from the end surface of the end of the working portion 1 to a first graduation line is 2 mm, a distance between two adjacent graduation lines is 2 mm, and the graduations 3 are respectively 2 mm, 4 mm, 6 mm, 8 mm, 10 mm, 12 mm, 14 mm in sequence. The distance from the end surface of the end of the working portion 1 to the first graduation line is able to be shortened for obtaining accurate data while using.

In the preferred embodiment, the osteotome for transcrestal sinus floor elevation is made of 2Cr13 stainless steel after quenching and tempering. The 2Cr13 stainless steel is Martensitic stainless steel with a higher hardness than Austenitic stainless steel. The machining process is as below. An overall shape of the osteotome is lathed by a lathe, and then the working portion 1 is processed by a grinder, and finally the working portion 1 is marked with the graduations 3 by laser etching.

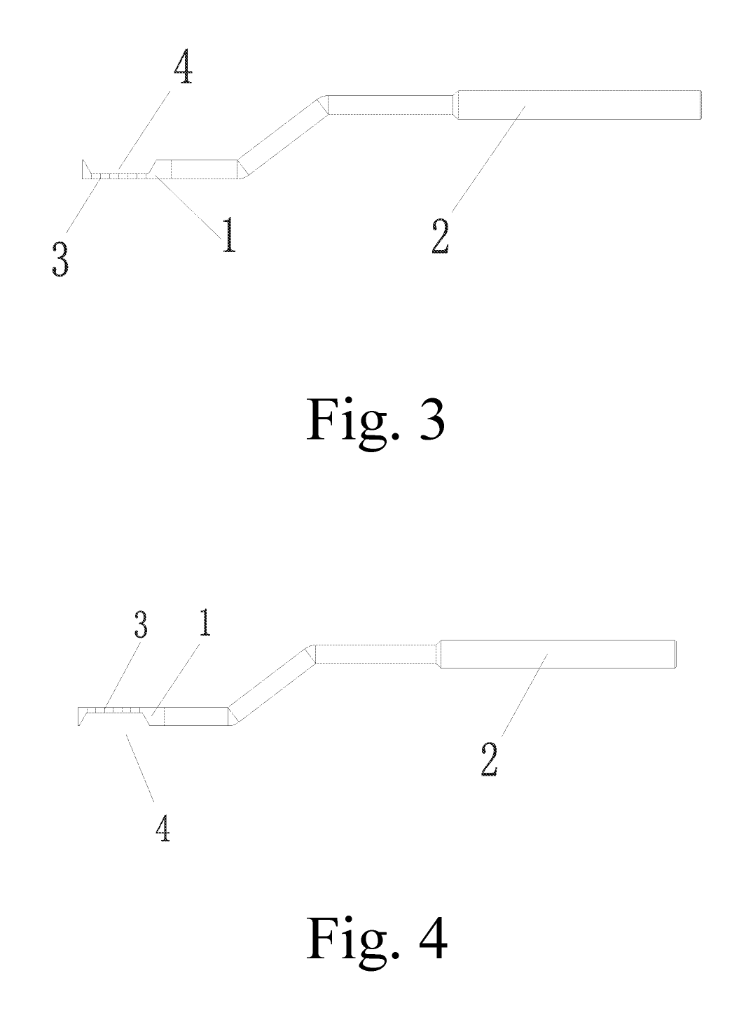

In the preferred embodiment, a diameter of the osteotome for transcrestal sinus floor elevation can be 2.8 mm, 3.5 mm or 4.1 mm. There are totally nine osteotomes, three osteotomes are provided at an anterior tooth region, six osteotomes (namely, three pairs) are provided at a posterior tooth region. For the three osteotomes, provided at the anterior tooth region, the handle 2 is straight. For the six osteotomes, provided at the posterior tooth region, the handle 2 is curved, as shown in FIGS. 3 and 4. Each pair comprises an osteotome for transcrestal sinus floor elevation A and an osteotome for transcrestal sinus floor elevation B, wherein the osteotome for transcrestal sinus floor elevation A and the osteotome for transcrestal sinus floor elevation B are used in pairs, the difference between the osteotome for transcrestal sinus floor elevation A and the osteotome for transcrestal sinus floor elevation B is the notch 4 on the working portion 1 has opposite opening directions.

During dental implant repair, the transcrestal maxillary sinus floor elevation technique has simple operation, little trauma, and slight postoperative reaction, is easily accepted by patients. However, it is limited while the elevation amplitude approaches or exceeds 5 mm, the risk of penetrating through the sinus floor mucosa is increased; once the sinus floor mucosa is penetrated through, it is hard to remedy.

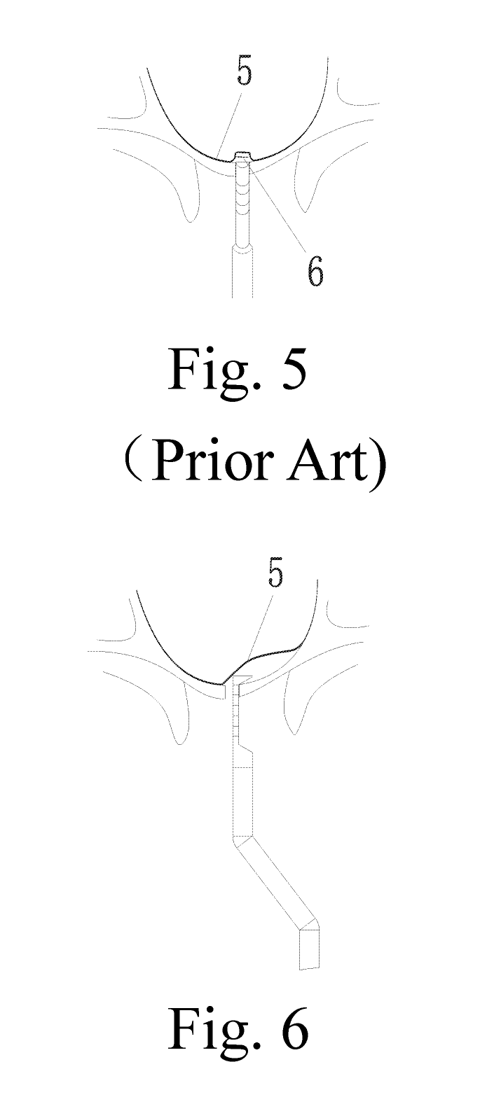

The use of the osteotome for transcrestal sinus floor elevation, disclosed by the present invention, is described in detail as below. To convenient for understanding, the structure of the maxillary sinus floor is firstly brief described, referring to FIG. 5. The maxillary sinus floor has sinus floor sclerotin 6 with a thickness of 1 mm, and sinus floor mucosa 5 is attached on the sinus floor sclerotin 6. The object of surgery is to peel off the sinus floor mucosa 5 from the sinus floor sclerotin 6.

As shown in FIG. 5, the conventional elevation osteotome needs thrusting the sinus floor sclerotin 6 with the thickness of 1 mm. Taking an elevation osteotome with a diameter of 4.1 mm as an example, the conventional osteotome is only capable of elevating the maxillary sinus floor with a diameter of 4.1 mm, and being used while a thickness of alveolar bone is larger than 5 mm.

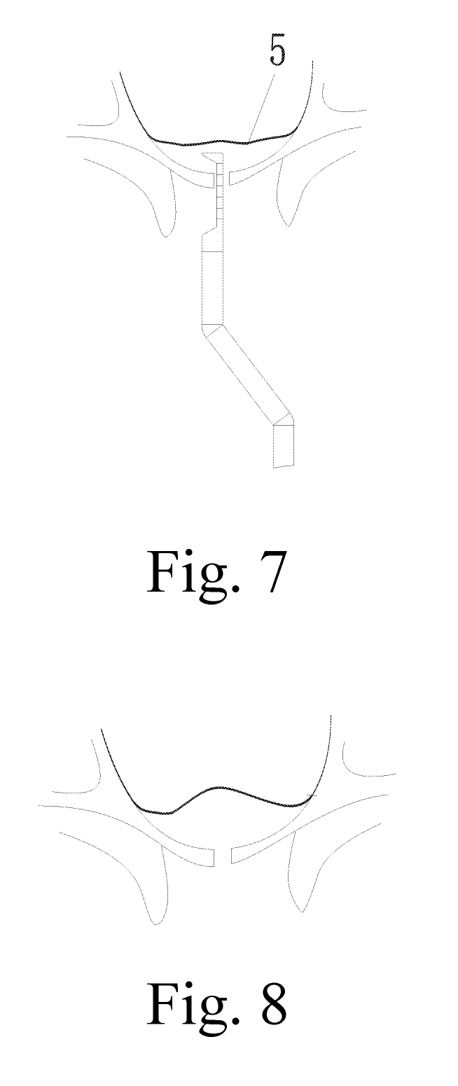

However, while using the osteotome for transcrestal sinus floor elevation of the present invention in surgery, due to the notch 4 provided on the working portion 1 of the osteotome, the scope of the maxillary sinus floor is able to be elevated to 8.2 mm. And, the present invention is able to be used for the alveolar bone with the thickness of 2 mm-4 mm. Referring to FIG. 6, under the premise of preparing the implanting tooth crypt holes with the same diameter, the osteotome for transcrestal sinus floor elevation A is capable of gradually peeling off the sinus floor mucosa 5 at a right side all around after going deep into the maxillary sinus, that is to say, the sinus floor mucosa 5 at the right side is detached from the sinus floor sclerotin 6, a working range is 180° at the right side. Referring to FIG. 7, under the premise of preparing the implanting tooth crypt holes with the same diameter, the osteotome for transcrestal sinus floor elevation B is capable of gradually peeling off the sinus floor mucosa 5 at a left side all around after going deep into the maxillary sinus, that is to say, the sinus floor mucosa 5 at the left side is detached from the sinus floor sclerotin 6, a working range is 180° at the left side. Finally, the maxillary sinus floor forms the structure as shown in FIG. 8.

The osteotome for transcrestal sinus floor elevation A and the osteotome for transcrestal sinus floor elevation B are used in pairs, are respectively responsible for 180° region to enlarge the lifting range of the maxillary sinus floor, thus the elevation amplitude of the maxillary sinus floor is improved to overcome the difficulties of the conventional transcrestal maxillary sinus floor elevation technique.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An osteotome for transcrestal sinus floor elevation, comprising a working portion and a handle, wherein a notch is provided on the working portion for peeling off maxillary sinus floor mucosa all around to enlarge a lifting scope of maxillary sinus floor, and an end surface of the working portion is a plane.

2. The osteotome for transcrestal sinus floor elevation, as recited in claim 1, wherein an end thickness of the working portion is from 0.3 mm to 1.5 mm.

3. The osteotome for transcrestal sinus floor elevation, as recited in claim 2, wherein a diameter of the working portion is 2.8 mm, 3.5 mm or 4.1 mm.

4. The osteotome for transcrestal sinus floor elevation, as recited in claim 3, wherein both the working portion and the handle are made of 2Cr3 stainless steel.

5. The osteotome for transcrestal sinus floor elevation, as recited in claim 1, wherein the handle is straight or curved.
